(19) United States
(12) Patent Application Publication
(10) Pub. No.: US 2010/0198627 A1
(43) Pub. Date: Aug. 5, 2010

(54) SYSTEM AND METHOD FOR IMPLEMENTING BIBLE BASED TRAVEL

(76) Inventor: Elisa L. Moed, Ra'ananna (IL)

Correspondence Address: The Law Office of Michael E. Kondoudis, 888 16th Street, N.W., Suite 800, Washington, DC, 20006, US

(21) Appl. No.: 12/697,325

(22) Filed: Feb. 1, 2010

Related U.S. Application Data
(60) Provisional application No. 61/148,402, filed on Jan. 30, 2009.

(51) Int. Cl. G06Q 50/00; G06Q 30/00; G06F 17/30

(52) U.S. Cl. 705/5; 705/27; 707/802; 707/769; 707/E17.044; 707/E17.014; 715/733

(57) ABSTRACT

A system, method and device is provided for enabling Biblical based travel planning, comprising a web portal engine, a Biblical travel server, a Biblical database, a travel database, and a communications network, wherein the Biblical database includes data relating to Biblical sources.

### CROSS REFERENCE TO RELATED APPLICATION

This application claims priority from U.S. Provisional Patent Application No. 61/148,402, filed 30 Jan. 2009, entitled “SYSTEM AND METHOD FOR IMPLEMENTING BIBLE BASED TRAVEL”, which is incorporated in its entirety herein by reference.

### FIELD OF THE INVENTION

The present invention relates to systems and methods useful in enabling Biblical based travel planning

### BACKGROUND OF THE INVENTION

Online travel planning and online communities are known to help users plan and execute travel bookings remotely. Many known travel planning sites provide users with travel focused information as well as social forums for interacting with fellow travelers. Further, many travel sites provide travelers with itineraries, maps and even travelogs.

Further, there are many sites that may help users search for religious texts, religious sources and content. There are even sites that enable users to research Biblical texts, questions, people and places.

However, no art is known that integrates Biblical content and travel content. It would be highly advantageous to have a travel planning site with dedicated tools for facilitating Biblical based travel.

### SUMMARY OF THE INVENTION

There is provided, in accordance with an embodiment of the present invention, an apparatus, system, and method for enabling remote users to search the Bible and to retrieve Biblical, travel and user-generated travel content, based on the Biblical search.

In some embodiments a system, method and device is provided for enabling Biblical based travel planning, including a web portal engine, a Biblical travel server, a Biblical database, a travel database, and a communications network, wherein the Biblical database includes data relating to Biblical sources.

In further embodiments a method is provided for enabling Biblical based travel planning, including conducting a Biblical search; querying a Biblical database; querying a travel database; processing results from both the Biblical database and the travel database to generate integrated Biblical-travel results; and delivering integrated Biblical-Travel results to a user.

In still further embodiments a device is provided for facilitating Biblical based travel planning, including an interactive embedded object for enabling remote Biblical-travel searches, where the device is in communication via a data network with a Biblical database, a travel database, and a Biblical-travel server, and where the server is adapted to integrate search results from the Biblical database and the travel database.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic diagram of a Biblical based travel system, according to some embodiments; and

FIG. 2 is a schematic block diagram of a process of implementing Biblical based travel, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details.

The word “Bible” as used herein may encompass the old testament, new testament, holy texts, sacred writings of the Christian religions, the Jewish religion, the Hebrew Scriptures, the Islamic religion and scriptures, Eastern religions and scriptures, or other religions, scriptures or traditions. Further, usage of the “Bible” may include various versions, translations and editions of the Biblical text or tradition, or other religious texts or traditions.

Embodiments of the present invention enable remote users to search the Bible and to retrieve Biblical, travel and user-generated travel content, based on the Biblical search. The Bible is currently a searchable entity, whereby users may search for information, verses, keywords, names etc. Internet based searches allow remote users to access such Biblical databases, typically from content web sites. According to some embodiments, Biblical searches are adapted to be used to generate travel-related results, for example, to generate relevant data about hotels, tours, and other user content that relates to the word or phrase inputted in the Bible search. The usage of such Biblical based searches to provide travel related results and services is hereinafter referred to as Biblical related travel, Bible based travel, or Biblical-travel.

In some embodiments, the Biblical generated travel data integrates the Bible and the Travel content. It is known, for example, that the interest in the Bible is a primary reason for visitation to the Holy Land. According to one example, the generation of a Bible based search results that provides Biblical results, travel products, and travel related results (e.g., user reviews, travel blogs, related holy sites and attractions) connects the Bible and travel in a very clear way for the user and may enhance knowledge and itinerary planning, and encourage travel and travel purchases. In other embodiments the Biblical generated travel data integrates the religious and Travel content in other lands, regions and cultures, besides the Holy Land.

In some embodiments a database of commentaries on Biblical texts may be coupled to the website engine, such that a user search may generate results that may incorporate Biblical commentaries, insights, comments, opinions etc. Such a feature may be used to help a user educate themselves about the person, place or thing being researched. Further, such results may be used to generate travel services, make bookings, promote business, generate advertisements, create publicity, encourage commerce etc.

In another example, provision of Bible based search results is very useful to the user who is researching travel to the holy land, or another selected location, and is using the Bible as a guide or reference tool for trip planning, travel booking, or content development. For example, the potential traveler may wish to visit places mentioned in the Bible, follow the footsteps of people mentioned in the Bible, or learn more about selected Biblical teachings. Relevant data is hereby provided, optionally displaying related results substantially in real time, in a user friendly, interactive display.

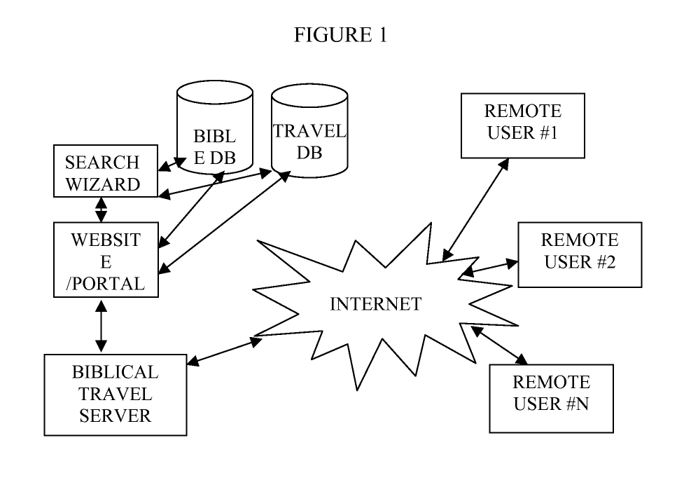

Reference is now made to FIG. 1, which is a schematic block diagram illustration of a Biblical based travel system, according to some embodiments. As can be seen in FIG. 1, the system may include a Website or Web portal engine, which includes the Website data, coupled to or hosted by a Biblical travel server, which is connected to the Internet, Intranet or other communications network. The web engine is coupled to one or more databases, including a Biblical database (e.g., www.Biblesq1.net, or other searchable Biblical databases, optionally in a variety of languages), and a travel database. The Biblical database, for example, may include Biblical related data, Biblical texts, Biblical maps, Biblical commentaries, Biblical studies data, Biblical statistics, Biblical names etc. The travel database may include, for example, travel related data. For example, travel related data may include accommodations, tours, services, places, names, educational content, service providers, articles, books, forums, blogs, museums, sites of attraction, events, pictures, songs, videos, itineraries, weather, traffic, maps, archaeological data, historical data, geographical data, etc. Travel related data may include data about Israel, the Promised Land, Palestinian Territories, Jordan, Gaza, Egypt, Iraq, Iran, Lebanon, Syria, or in other countries, areas, regions or continents. In other embodiments travel related data may include data about countries, cities, regions or areas globally. Other databases may be used to provide relevant data in accordance with the Biblical search conducted.

In some examples, a Bible search will search the Biblical database(s) for the phrase or verse that contains the word or phrase from the Bible. The search may further search the travel database(s) for related travel content, and present the Bible results and the travel results on the search results page, optionally at the same time or in the same view. In further embodiments a website database may be incorporated in the Biblical travel search system, that may include web site data and/or user generated data. For example, the user generated data may be developed based on user comments, rankings, opinions, stories, pictures, videos, articles etc. In an additional example, the site engine may be coupled to external databases to enable selected searches and deliver selected content, based on or integrating one or more external databases. For example, one or more travel databases may be used or integrated into the search results. The above described databases may be incorporated in the search mechanism, such that a user search may include user generated, site generated and/or external content.

In some embodiments the Bible search system may include a search results wizard module, for processing the search results for display to the user, in accordance with advanced results features. The wizard module may be coupled to the databases and the Website or portal engine. For example, the displayed results may be categorized by what they are and where they are from. For example, the results may be tagged, filtered, labeled or placed in accordance with their data source (e.g., Bible database or travel database); their travel type (e.g., attractions, museums, accommodations, service provider, Christian guesthouses etc.); their content type (e.g., tours, itineraries, educational guidelines, expert blogs etc.); and/or their data type (e.g., pictures, audio files, video files, maps etc.). Other relevant criteria or classifications may be used, some of which are described below. One more client communication or communication devices may connect to the Web engine, via the Internet, using a variety of communication networks. For example, users of desktop computers, mobile computers, cellular phones, or other relevant computing or communication devices may connect to the Bible based travel system using the device's communication and/or networking features.

According to an embodiment of the present invention, Biblical searches may be used to find places of interest, including historical sites, holy sites, attractions, hotels, tours, businesses, people, entertainment, products and services that are related to the searched elements. According to further embodiments Biblical searches may be used to plan Biblical travel itineraries, and to create Biblical travelogs (or travel logs) based on a users Biblical travel experience. For example, a user may generate a travelog, diary or record of Biblical travel experiences, optionally based on his or her Biblical itinerary, plans, research and/or actual experience.

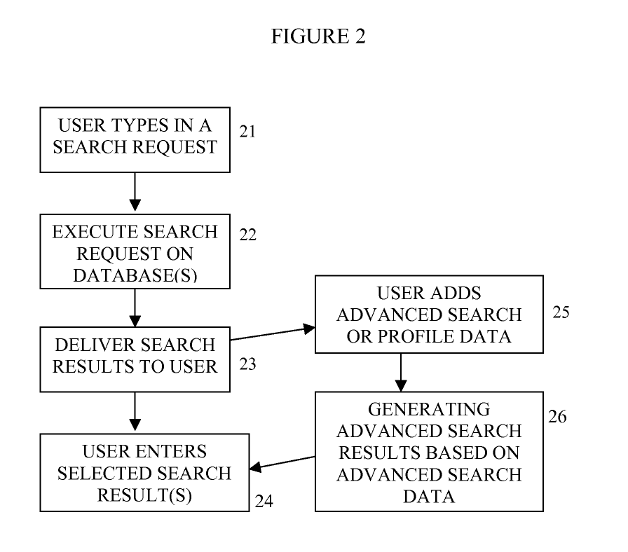

FIG. 2 schematically illustrates a series of operations or processes that may be implemented to enable Biblical based travel searching, according to some embodiments. As can be seen in FIG. 2, at block 21 a user, optionally using a remote computer or computing device, types in a word or phrase into a search box, for example, a “search the Bible” search box. Optionally, the user may enter a place, phrase, person, verse or passage from the Bible using free text, Boolean expressions, predictive text, drop down texts etc. At block 22 the user search will be executed on at least the Biblical database and the travel database. At block 23 the Biblical and/or travel results will be delivered by the server to the user's computing device, where they will be displayed in accordance with the user device settings and/or application. In some embodiments the Biblical database results and the travel database results may be processed, separately and/or together, and the results may be thereby integrated together into what is hereinafter referred to as Biblical-travel results. At block 24 the user may select one or more results, to either learn more about the result(s), make a booking, register his/her name, transfer to a relevant Website or document etc. In some embodiments, at block 25, a user may add advanced search or profile data, for example, comment on a search result, rank a search result or tag a search result. For example, a user may undertake an advanced or additional search, optionally within the results from the user's primary search, base upon the user's profile, information added, comments, or other criteria. At block 26 advanced search results may be generated in accordance with the user added advanced search data. For example, relevant comments, ranks, tags etc. may be used to filter and/or display the results data to the user.

In some embodiments the word or phrase inputted in the search may be emphasized, bolded, underlined, hyperlinked or highlighted within the sentences, verses etc. that they are found in the Bible and/or the travel database. For example, the Biblical search may also generate, optionally in separately identified components displayed on the same page, related search results for tours/itineraries, Expert Blogs, Christian Guesthouses, User generated blogs, related pictures and videos etc. The results of the non-Biblical search results may be filtered, displayed or selected in relation to the Biblical search results, according to the way in which the content has been tagged, marked, ranked, etc. For example, if a holy site, guest houses, itinerary (that may include Jerusalem) a hotel (in Jerusalem), expert blog (that is about Jerusalem), picture, video, or other user generated content that relates to Jerusalem, is tagged “jerusalem”, it will then show up in a Biblical search result on “Jerusalem”. In some embodiments the tagging may include advanced tagging features or meta data features that may include data such as search popularity, accuracy of search expression, user rank, trustworthiness grading, expert or user recommendation, or other relevant classifications or criteria. Usage of such tags and/or metadata may enable more accurate, customized, qualitative etc. filtering, ordering and displaying of search results. Any combination of the above steps may be implemented. Further, other steps or series of steps may be used.

According to some embodiments, a remote tool for enabling Biblical based travel is provided, hereinafter referred to as a Biblical travel widget. In one example an interactive object such as a search box may be delivered, uploaded, downloaded or otherwise transferred to one or more websites, platforms, portals etc. This interactive object may subsequently be used my remote users in the respective sites, platforms or portals etc. to generate search results or other data requests directly with the Biblical database and the travel database, optionally providing integrated Biblical-travel results, as described above. According to some examples, a Biblical travel widget may be provided for Social Networking sites such as Facebook, Linked In, Twitter and others. In further examples a Biblical travel widget may be provided for Web portals such as Yahoo and MSN, or for platforms such as Google. In yet additional examples a Biblical travel widget may be provided for mobile networks, mobile computers or phones, such as the IPhone, Blackberry, Nokia devices or other communications devices.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for enabling Biblical based travel planning, comprising a web portal engine, a Biblical travel server, a Biblical database, a travel database, and a communications network, said Biblical database including data relating to Biblical sources.

2. The system of claim 1, further comprising a search Wizard for enabling smart searches directly to said Biblical database and to said travel database.

3. The system of claim 1, wherein said Biblical travel server integrates travel data from said travel database into said Biblical data from said Biblical database.

4. A method for enabling Biblical based travel planning, comprising: conducting a Biblical search; querying a Biblical database; querying a travel database; processing results from both said Biblical database and said travel database to generate integrated Biblical-travel results; and delivering integrated Biblical-Travel results to a user.

5. The method of claim 4, further comprising making travel bookings based on said Biblical-Travel results.

6. The method of claim 4, further comprising automatically creating a Biblical travel itinerary.

7. The method of claim 4, further comprising creating a Biblical travelog.

8. The method of claim 4, wherein said Biblical Search is initiated via a remote application on an external Website.

9. A device for facilitating Biblical based travel planning, comprising: an interactive embedded object for enabling remote Biblical-travel searches, the device being in communication via a data network with a Biblical database, a travel database, and a Biblical-travel server, said server adapted to integrate search results from said Biblical database and said travel database.

10. The device of claim 9, wherein said interactive object is uploaded on one or more interfaces selected from the group consisting of Websites, Web platforms, Social Networking sites, Web portals and mobile networks.
